(19) United States
(12) Patent Application Publication
(10) Pub. No.: US 2008/0032658 A1
(43) Pub. Date: Feb. 7, 2008

(54) Analog front end device

(75) Inventors: Jui-Yuan Tsai, Tai Nan City (TW); Yu-Pin Chou, Tung Hsiao Town (TW)

Correspondence Address: BIRCH STEWART KOLASCH & BIRCH, PO BOX 747, FALLS CHURCH, VA, 22040-0747, US

(73) Assignee: REALTEK SEMICONDUCTOR CORP.

(21) Appl. No.: 11/882,039

(22) Filed: Jul. 30, 2007

(30) Foreign Application Priority Data
Aug. 4, 2006 (TW) 095128587

(51) Int. Cl. H04B 1/26

(52) U.S. Cl. 455/313

(57) ABSTRACT

The invention discloses an analog front end device comprising a band-gap voltage reference circuit and at least one conversion circuit, wherein the conversion circuit includes a clamper, an input buffer, a low-pass filter, a high frequency gain unit and an analog to digital converter. The analog front end device utilize a high frequency gain unit to increase high frequency gain of the image analog signal for increasing the usable number of sampling phase of the image analog signal.

### BACKGROUND OF THE INVENTION

(a) Field of the Invention

The invention relates to an image processing device, particularly to an analog front end device.

(b) Description of the Related Art

Since the 20th century, the development of the television technology and its applications has proved that it is now part of human life and entertainment. Because of the improvement of display technology in recent years, providing massive information and high-definition images has become the guideline of future development of the television industry. Please refer to FIG. 1, showing a schematic diagram of a typical television system and its video source. As shown in FIG. 1, the video source system 110 transmits video data in analog signal format to a television system 120 for displaying video pictures. Although digitized transmission interfaces are already available, analog transmission interfaces remain the most commonly used form of interface.

The video source of the television system 120 can have many forms, such as a DVD player, set top box, and even various game consoles. In general, the components of the video source system 110 comprise a video encoder 112 for performing image data encoding. Then, a digital-to-analog converter (DAC) 114 converts the encoded digital signal into an image analog signal and transmits it.

The television system 120, such as a LCD TV or other flat panel television system or digital television system that is becoming the main stream application, receives an image analog signal transmitted from the video source, converts it into digital format via an analog-to-digital converter (ADC) 124, and performs decoding operation via a video decoder 122 for further image processing and displaying.

There are many types of video encoding formats. The widely seen ones are: RGB format, CVBS format, luminance/chrominance (YC) format, and YPrPb format. Therefore, the analog transmission interface for transmitting video signals between the video source system 110 and the television system 120 can also have several types, such as AV interface for transmitting a signal in CVBS format; S-video interface for transmitting a signal in YC format; and component video interface for transmitting a signal in YPrPb format, etc.

FIG. 2A shows the waveform of the image analog signal that is processed in the television system 120 (for example, in the form of R, G, B signals or in the form of Y, Pr, Pb signals) and the waveform of a pixel clock signal CLK generated by the television system 120 according to the horizontal synchronizing signal HS (not shown in the figure) of the video source system 110. Here it is assumed that the image resolution of the analog signals, such as R, G, B, is set to be 1600×1200, the frequency of the horizontal synchronizing signal HS is at 93.8 KHz, and the frequency of the pixel clock signal CLK is at 202.5 MHz (a period of 4.94 ns). Therefore, the period of every signal level Ph (as shown in the dotted circle in FIG. 2A) of the R, G, B signals are also equal to 4.94 ns.

FIG. 2B shows an enlarged diagram of a single signal level Ph, where the signal level Ph comprises N sampling phases (as indicated by solid arrows), each arrow represents one sampling phase, and N is a positive integer. In general, the quality of the television system 120 is evaluated by using a standard test picture (for instance: a picture with a pure black portion and a pure white portion) to check the number of usable sampling phases within each signal level Ph. Obviously, a larger number of usable sampling phases indicates that the television system 120 has better image processing effect and therefore its display quality is better. For example, if each signal level Ph is equally divided into 32 divisions for a pixel clock signal CLK with frequency of 202.5 MHz (a period of 4.94 ns), the N in FIG. 2B is equal to 32, which means each signal level Ph now has 32 sampling phases, and each sampling phase has a width of 154 ps (4.94 ns/32=154 ps). Under ideal situation, each signal level Ph should have 32 usable sampling phases. However in reality, when the image analog signals R, G, B are transmitted in the external cable between the video source system 110 and the television system 120, are propagating inside the television system 120, or are filtered by a low pass filter (not shown) in the television system 120 to filter out high frequency noises, high frequency attenuation phenomenon appears in the image analog signals R, G, B. And by further taking into account the jitter phenomenon inherent to the pixel clock signal CLK of the television system 120, all these significantly decrease the number of usable sampling phases of each signal level Ph of the image analog signals R, G, B (i.e., N<32), as shown in FIGS. 3A and 3B.

As can be seen in FIG. 3A, the high frequency attenuation phenomenon happens in the front edges of every signal level Ph. From the enlarged diagram of the signal level Ph illustrated in FIG. 3B, as the front edge of the signal level Ph (the circled portion F1 with dotted line in FIG. 3B) attenuates downward, the number of usable sampling phases of the entire signal level Ph decreases to N1, where N1<N and N1, N are positive integers. Therefore, when the image analog signals R, G, B are influenced by the high frequency attenuation or jitter happened in the pixel clock signal CLK, the number of usable sampling phases of the image analog signals R, G, B decreases, and thereby worsens the display quality of the television system 120. Similar problem also appears in systems adopting other signal format, such as the YPrPb format mentioned above.

In general, the above-mentioned problem is solved with two approaches: the first approach is to design a clock generator having very high quality to generate a pixel clock signal CLK so that jitter does not easily happen in the television system 120; and the second approach is to remove the low pass filter that is used to filter out the high frequency noise in the television system 120. However, the cost of the first approach is too high while the second approach results in unacceptable high frequency noises in the image analog signals, which cause signal distortion. Therefore, how to provide a television system 120 having the advantages of reduced cost, reduced high frequency attenuation in the input image analog signal, increased number of usable sampling phases of each signal level, and maintaining acceptable noise immunity, has become a bottleneck that draws extensive attention.

### BRIEF SUMMARY OF THE INVENTION

In light of the above mentioned problem, one object of the invention is to provide an analog front end device, which reduces the cost, reduces the high frequency attenuation of the input image analog signal, increases the number of usable sampling phases of the signal, and meanwhile maintains acceptable noise immunity.

One embodiment of the invention provides an analog front end device, applied in a television system for receiving at least one image analog signal and generating at least one digital signal. The analog front end device comprises a bandgap voltage reference circuit and at least one conversion circuit. The bandgap voltage reference circuit is used for generating a reference voltage. The conversion circuit comprises a clamper, an input buffer, a low-pass filter, a high frequency gain unit, and an analog-to-digital converter. The clamper receives the image analog signal, resets the DC voltage level of the image analog signal, and generates a re-leveled signal. The input buffer buffers the re-leveled signal according to the reference voltage and then generates a buffered output signal. The low-pass filter receives the buffered output signal, filters the high frequency noise of the buffered output signal, and then generates a filtered signal. The high frequency gain unit receives the filtered signal, increases the high frequency gain of the filtered signal, and then generates an output signal. The analog-to-digital converter converts the output signal into a digital signal according to the reference voltage.

The analog front end device according to one embodiment of the invention, with the attributes of the high frequency gain units in the conversion circuits, which slightly reduce the gain at low frequency band and considerably increase the gain at high frequency band during signal processing, can eliminate the high frequency attenuation phenomenon of the image analog signal resulting from high frequency processing, so as to increase the gain of the attenuation portion of the signals and to increase the number of usable sampling phases. Therefore, the goals of reducing cost by sparing an expensive, higher-order clock generator which generates a jitter-resistive pixel clock signal, reducing high frequency attenuation in the input image analog signal, increasing number of usable sampling phases of each signal level, and maintaining original noise immunity, can be simultaneously achieved.

### BRIEF DESCRIPTION OF THE DRAWINGS

FIG. 1 shows a schematic diagram illustrating a television system and its video source.

FIG. 2A shows ideal waveform diagrams of an image analog signal, e.g., R, G, B, and a pixel clock signal CLK.

FIG. 2B shows an enlarged waveform diagram of the signal level Ph in the image analog signal, e.g., R, G, B, as shown in FIG. 2A.

FIG. 3A shows practical waveform diagrams of an image analog signal, e.g., R, G, B, and a pixel clock signal CLK.

FIG. 3B shows an enlarged waveform diagram of the signal level Ph in the image analog signal, e.g., R, G, B, as shown in FIG. 3A.

FIG. 4 shows a schematic diagram illustrating an analog front end device according to one embodiment of the invention.

FIG. 5A shows a waveform diagram of the image analog signal RGB/YPrPb after modification.

FIG. 5B shows an enlarged waveform diagram of the signal level Ph in the image analog signal RGB/YPrPb, as shown in FIG. 5A.

FIG. 6 shows a schematic diagram illustrating a high frequency gain unit according to one embodiment of the invention.

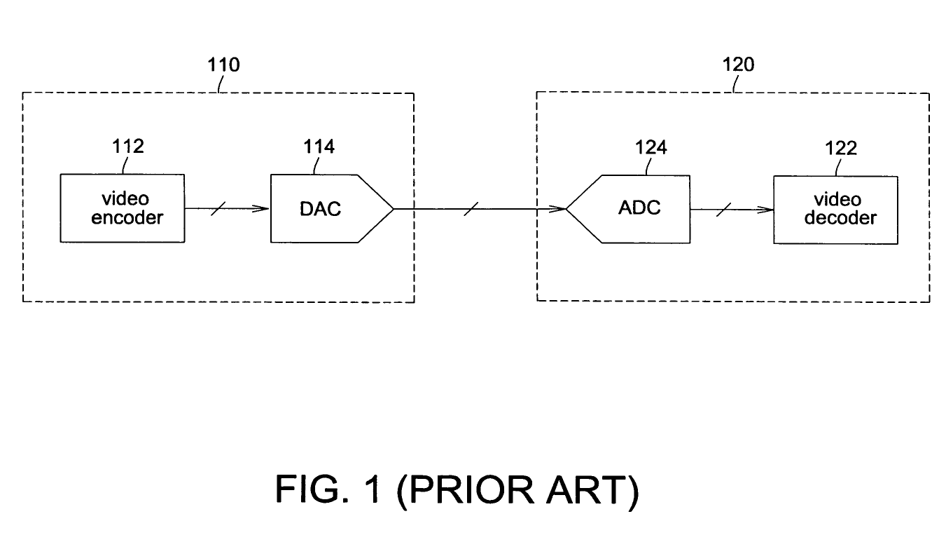

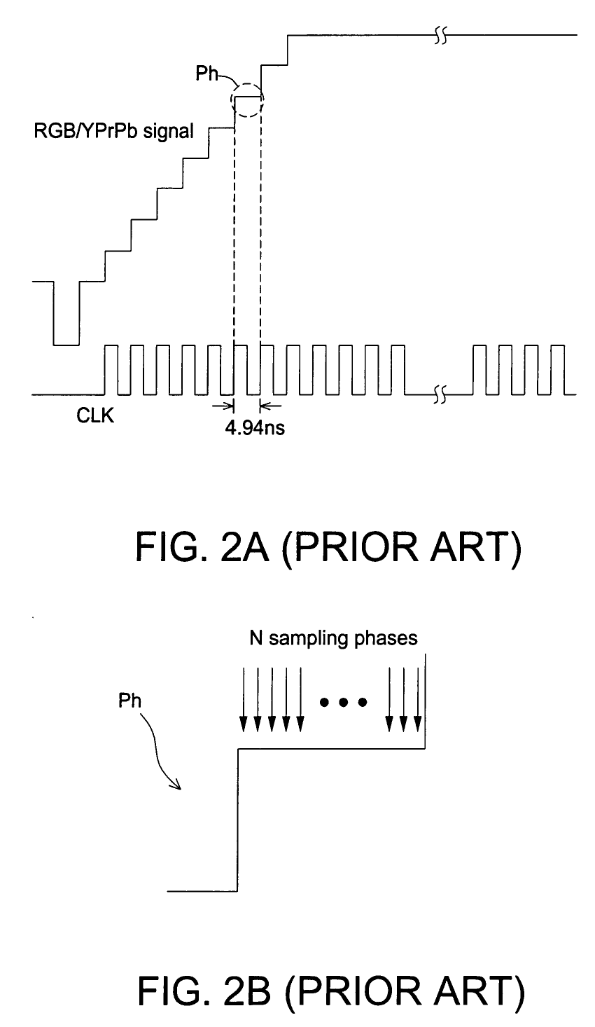

### DETAILED DESCRIPTION OF THE INVENTION

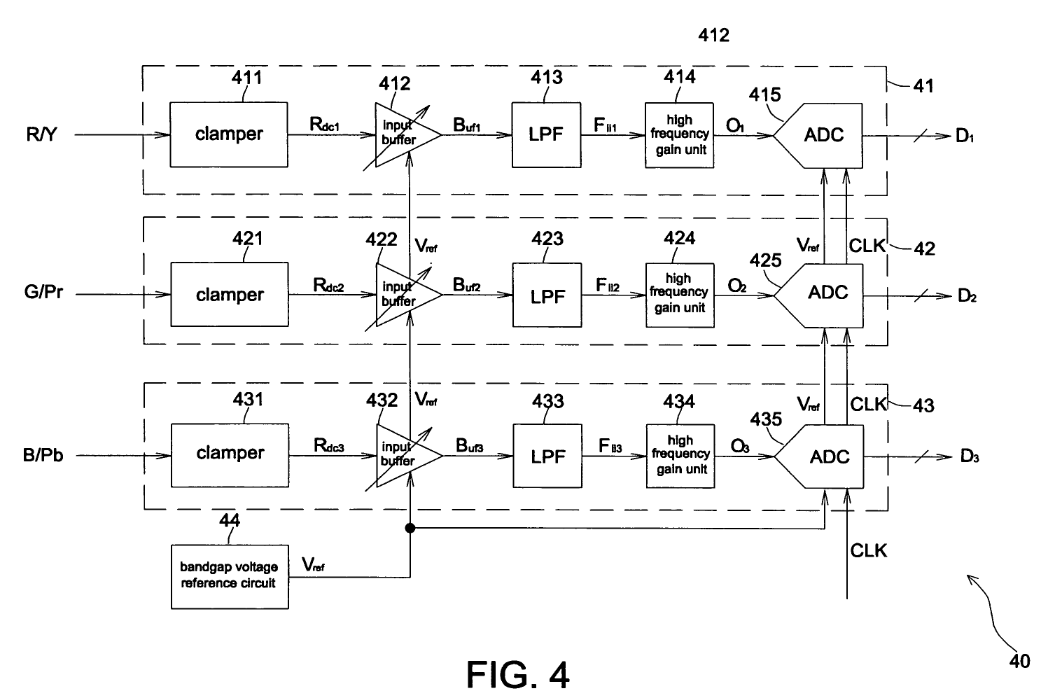

FIG. 4 shows an analog front end device 40 applied in a television system 120 according to one embodiment of the invention. In this embodiment, an digital-to-analog converter 114 in a video source system 110 outputs an image analog signal and transmits it to the analog front end device 40 via a transmission medium (not shown in the figure). After processed by the analog front end device 40, the signal is outputted to a video decoder 122 for decoding. In this embodiment, the format of the image analog signal comprises an image data component, such as RGB signal, CVBS signal, YC signal, YPrPb signal, or the like. However, applications of the invention are not limited by these examples. Any existing video format or future format to be developed can also apply the concept of the invention. Moreover, although the above-mentioned embodiment is based on a television system used as an example of an image display device, the invention is not limited by this example. For simplicity, the following description is based on the RGB signal and the YPrPb signal.

On the other hand, it can be understood for those who are skilled in the image processing technology that the above-mentioned transmission medium can be implemented by wired (such as cable or the like), wireless (such as radio frequency antenna or the like), or various existing or innovative methods. In this embodiment, the transmission medium is implemented by a cable (that is, a wired method) conforming to the above-mentioned signal format.

The analog front end device 40 receives the image analog signals R, G, B/Y, Pr, Pb and converts the plurality of image analog signals R, G, B/Y, Pr, Pb into digital signals D₁, D₂, and D₃. The analog front end device 40 comprises a first conversion circuit 41, a second conversion circuit 42, a third conversion circuit 43, and a bandgap voltage reference circuit 44. The first conversion circuit 41 comprises a clamper 411, an input buffer 412, a low-pass filter (LPF) 413, a high frequency gain unit 414, and an analog-to-digital converter 415. As shown in the figure, the structures of the three conversion circuits 41, 42, and 43 are the same. Therefore, further details regarding the components of the conversion circuits 42, 43 will not be repeated hereinafter.

The operation of the analog front end device 40 will be exemplified by the R, C, B signal format. At first, after receiving the R, G, B signals, respectively, the conversion circuits 41, 42, and 43 utilize the clampers 411, 421, and 431 to perform DC voltage level calibration on the respective signals to generate re-leveled signals R_{dc1}, R_{dc2}, and R_{dc3}, respectively. Then, the input buffers 412, 422, and 432 perform buffering processes on the re-leveled signals R_{dc1}, R_{dc2}, and R_{dc3} to generate buffered output signals B_{uf1}, B_{uf2}, and B_{uf3}, respectively. The low pass filters 413, 423, and 433 receive the buffered output signals B_{uf1}, B_{uf2}, and B_{uf3} respectively, and with the attributes of these filters, limit the bandwidths of the image analog signals, so as to reduce noises. Then, the low pass filters 413, 423, and 433 filter the signals to generate filtered signals Fᵢₗ₁, Fᵢₗ₂, and Fᵢₗ₃, respectively. The high frequency gain units 414, 424, and 434 receive the filtered signals Fᵢₗ₁, Fᵢₗ₂, and Fᵢₗ₃, respectively, and increase the high frequency gain of the filtered signals Fᵢₗ₁, Fᵢₗ₂, and Fᵢₗ₃ to generate output signals O₁, O₂, and O₃, respectively. The analog-to-digital converters 415, 425, and 435 receive the output signals O₁, O₂, and O₃ and convert them into the digital signals D₁, D₂, and D₃, respectively. On the other hand, the analog-to-digital converters 415, 425, and 435 also receive a pixel clock signal CLK to be used during sampling. At the same time, the bandgap voltage reference circuit 44 generates a reference voltage V_{ref}. The reference voltage V_{ref} is provided to the input buffers 412, 422, and 432, respectively, and is used to adjust the gain and the offset voltage of the input buffers 412, 422, and 432, respectively. Alternatively, the reference voltage V_{ref} is provided to the analog-to-digital converters 415, 425, and 435 to adjust the full scale voltage or bias current of the analog-to-digital converters 415, 425, and 435.

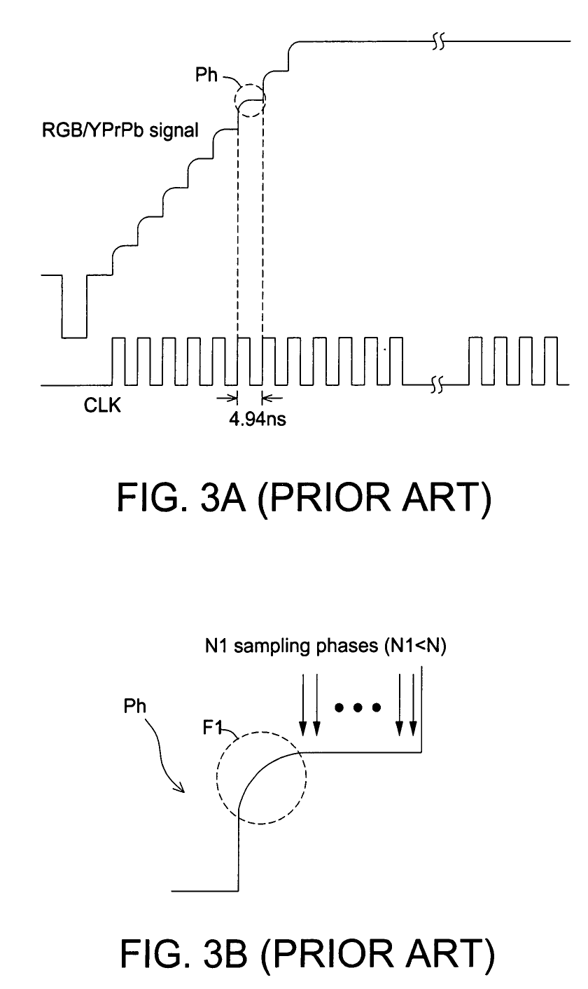

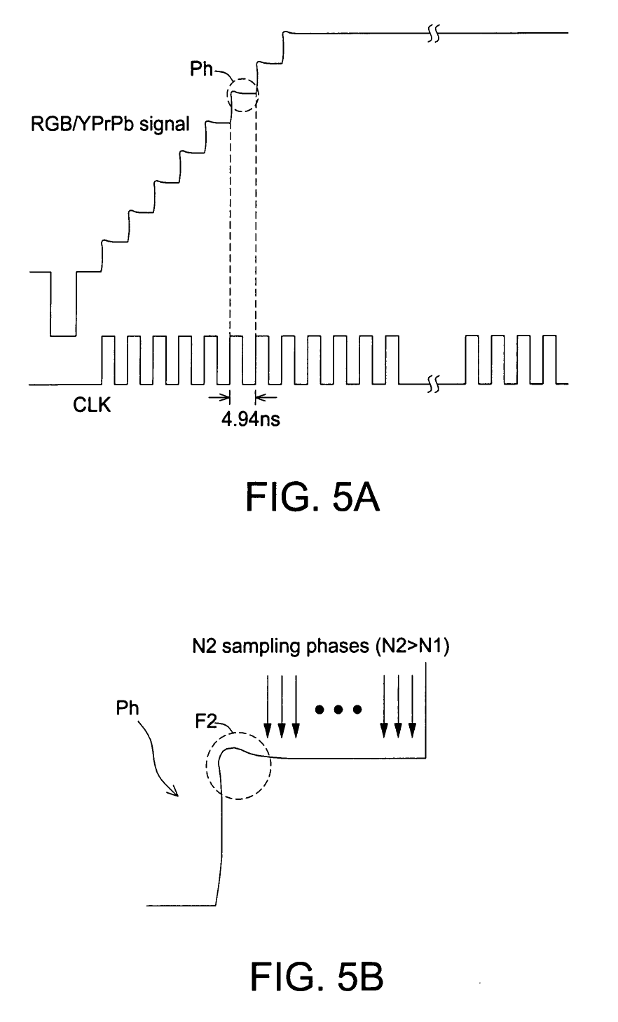

The analog front end device 40 of the invention, with the attributes of the high frequency gain units 414, 424, and 434 in the conversion circuits 41, 42, and 43, which slightly reduce the gain at low frequency band and considerably increase the gain at high frequency band during signal processing, can eliminate the high frequency attenuation phenomenon of the image analog signal R, G, B/Y, Pr, Pb resulting from high frequency processing, so as to increase the gain of the attenuation portion of the signals and to increase the number of usable sampling phases. As shown in FIGS. 3A and 3B, when the image analog signals R, G, B/Y, Pr, Pb suffer from the influences of external cable, internal circuitry, the low pass filter, and the clock generator and exhibit high frequency attenuation (as indicated by the signal level Ph in FIG. 3B), the number of usable sampling phases is reduced from the original N to N1, such as from a preset number of 32 to 22. Since the transients of the image analog signals R, G, B/Y, Pr, Pb from signal level to signal level are attributed high frequency variation, the high frequency gain units 414, 424, and 434 process the image analog signal R, G, B/Y, Pr, Pb and preferably overshoot the filtered signals Fᵢₗ₁, Fᵢₗ₂, and Fᵢₗ₃ so as to increase the gain of the signals. The waveforms of the signals after processed by the high frequency gain units 414, 424, and 434 are shown in FIGS. 5A and 5B. As shown in FIG. 5A, the front edge of each signal level Ph is overshot by increased high frequency gain. From the enlarged diagram of the signal level Ph in FIG. 5B, because of the high frequency gain increase, which results in waveform shaping at the front edge of the signal level Ph, the width of the flat portion of the whole signal level Ph waveform increases and the usable sampling phases are changed from N1 to N2, where N2>N1 and N1, N2 are positive integers. For example, N1 is equal to 22 and N2 is equal to 28. Consequently, the high frequency gain units 414, 424, and 434 are used to increase the high frequency gain of the image analog signal R, G, B/Y, Pr, Pb, which in turn increases the number of usable sampling phases of the signal level Ph. Since the high frequency noises are filtered out by the low pass filters 413, 423, and 433 before the image analog signal R, G, B/Y, Pr, Pb is transmitted to the high frequency gain units 414, 424, and 434, increasing the gain of the signal by the high frequency gain units 414, 424, and 434 does not increase the noises that will affect the original noise immunity. Therefore, by adopting this method, the goals of reducing cost by sparing an expensive, higher-order clock generator which generates a jitter-resistive pixel clock signal CLK, reducing high frequency attenuation in the input image analog signal R, G, B/Y, Pr, Pb, increasing number of usable sampling phases of each signal level Ph, and maintaining original noise immunity, can be simultaneously achieved.

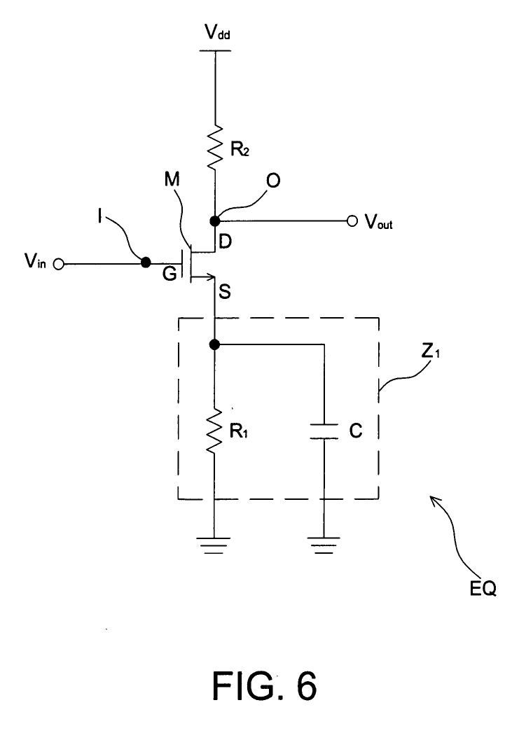

It should be noted that the high frequency gain units 414, 424, or 434 in the analog front end device 40 according to the embodiment of the invention can be implemented by equalizers or high-pass filters. As show in FIG. 6, an equalizer EQ is used to implement the high frequency gain unit 414, 424, or 434, according to one embodiment of the invention. The equalizer EQ comprises a first resistor R₁, a second resistor R₂, a MOS transistor M, and a capacitor C. The MOS transistor M of this embodiment is an NMOS transistor. Obviously, the MOS transistor can be of other types, such as a PMOS transistor in another embodiment. On the other hand, it can also be replaced by a bipolar junction transistor, field effect transistor, and so forth. Although the circuit configuration may be slightly different, the various types of transistors can be used as long as similar effect is achieved. As shown in the figure, one terminal of the first resistor R₁ is coupled to ground. One terminal of the second resistor R₂ is coupled to the power V_{dd}, the other terminal is defined as an output node O, and an output signal Vₒᵤₜ is extracted from the output node O. The gate G of the MOS transistor M is defined as an input node I, the input node I receives an input signal Vᵢₙ, the drain D is coupled to the output node O, and the source S is coupled to the other terminal of the first resistor R₁. One terminal of the capacitor C is coupled to ground while the other terminal is coupled to the source S of the MOS transistor M. The voltage gain between the input signal and the output signal of the circuit can be represented as:

Vₒᵤₜ/Vᵢₙ=(gₘ×R₂)/(1+gₘ×Z₁) (1.1)

wherein gm is transconductance of the small signal model of the transistor; Z₁ is the impedance of the parallel-connected resistor R₁ and capacitor C, and Z₁=R₁//(1/SC)=R₁/(SCR₁+1), where (1/SC) is the capacitive reactance value of the capacitor.

Therefore, when the input signal Vᵢₙ is a low frequency signal, the admittance SC of the capacitor becomes very small (it is assumed to be approximately zero), so that the impedance Z₁ is approximately equal to R₁, and the voltage of the output signal is:

Vₒᵤₜ={(gₘ×R₂)/(1+gₘ×R₁)}×Vᵢₙ (1.2)

When the input signal Vᵢₙ is a high frequency signal, the admittance SC of the capacitor becomes very large, so that the impedance Z₁ becomes very small (approximately zero), and the voltage of the output signal is:

Vₒᵤₜ={(gₘ×R₂)/1}×Vᵢₙ (1.3)

Assuming gₘ=10 (mS/mm), R₂=1.1 kohm, and R₁=1 kohm, when the input is a low frequency signal, the output signal Vₒᵤₜ in the equation (1.2) is approximately 1Vᵢₙ; and when the input is a high frequency signal, the output signal Vₒᵤₜ in the equation (1.3) is approximately 11Vᵢₙ. According to one embodiment of the invention, since the high frequency noises of the filtered signals Fᵢₗ₁, Fᵢₗ₂, and Fᵢₗ₃ are filtered out by the low pass filters 413, 423, and 433 before transmitted to the equalizer EQ, the compositions of the signals Fᵢₗ₁, Fᵢₗ₂, and Fᵢₗ₃ inputted to the equalizer EQ are left with almost only the image signals themselves. Furthermore, the gain of the low frequency portion of the input signal is only slightly reduced by the equalizer EQ, but the gain increase of the high frequency portion of the image signal is relatively large. Therefore, the equalizer EQ is used to implement the high frequency gain units 414, 424, and 434, to achieve the effects of raising the high frequency attenuation portion of the image analog signal R, G, B/Y, Pr, Pb, leveling the front edge of each signal level Ph, and increasing the number of usable sampling phases.

Although the present invention has been described by the embodiments with reference to the accompanying drawings, it should not construe any limitations on the scope of the present invention. Various modifications and changes can be made by those who are skilled in the art without deviating from the essence of the invention.

What is claimed is:

1. An analog front end device for receiving at least one image analog signal and generating at least one digital signal, the analog front end device comprising: at least one conversion circuit wherein the conversion circuit comprises:
a clamper for receiving the image analog signal, resetting DC voltage level of the image analog signal, and generating a re-leveled signal;
an input buffer for buffering the re-leveled signal according to a reference voltage and then generating a buffered output signal;
a low-pass filter for receiving the buffered output signal, filtering high frequency noise of the buffered output signal, and then generating a filtered signal;
a high frequency gain unit for receiving the filtered signal, increasing the high frequency gain of the filtered signal, and then generating an output signal; and
an analog-to-digital converter for converting the output signal into a digital signal.

2. The analog front end device according to claim 1, further comprising a bandgap voltage reference circuit for generating the reference voltage.

3. The analog front end device according to claim 1, wherein the image analog signal is selected from the group consisting of the following: one of original image signals (R, G, B), one of image color difference signals (Y, Pr, Pb), one of YC signals and a CVBS signal.

4. The analog front end device according to claim 1, wherein the high frequency gain unit is a high-pass filter.

5. The analog front end device according to claim 1, wherein the high frequency gain unit is an equalizer.

6. The analog front end device according to claim 5, wherein the equalizer comprises:
a first resistor wherein one terminal of the first resistor is coupled to ground;
a second resistor wherein one terminal of the second resistor is coupled to a power and the other terminal is designated as an output node;
a MOS transistor wherein the gate of the MOS transistor is designated as an input node, the drain is coupled to the output node, and the source is coupled to the other terminal of the first resistor; and
a capacitor wherein one terminal of the capacitor is coupled to ground and the other terminal is coupled to the source of the MOS transistor.
